(19) United States
(12) Patent Application Publication
(10) Pub. No.: US 2025/0251566 A1
(43) Pub. Date: Aug. 7, 2025

(54) APPARATUS AND IMAGE PICKUP APPARATUS

(71) Applicant: CANON KABUSHIKI KAISHA, Tokyo (JP)

(72) Inventors: MAKOTO HAYAKAWA, Tochigi (JP); KOHEI KIMURA, Saitama (JP)

(21) Appl. No.: 19/038,510

(22) Filed: Jan. 27, 2025

(30) Foreign Application Priority Data
Feb. 6, 2024 (JP) 2024-016198

(51) Int. Cl. G02B 7/10; G02B 7/02; G02B 7/09; G02B 27/64; G03B 13/36; G03B 17/12; H04N 23/55

(52) U.S. Cl. CPC G02B 7/102; G02B 7/021; G02B 7/09; G02B 27/646; G03B 13/36; G03B 17/12; H04N 23/55; G03B 2205/0046

(57) ABSTRACT

An apparatus includes a first focus lens, a second focus lens, a first actuator configured to drive the first focus lens, and a second actuator configured to drive the second focus lens. Predetermined inequalities are satisfied.

### DESCRIPTION OF RELATED ART

PCT International Publication WO 2020/170586 discloses a lens apparatus in which two focus lenses are driven by two actuators, respectively.

### BACKGROUND

### Technical Field

The aspect of the embodiments relates to a lens apparatus and an image pickup apparatus.

### SUMMARY

An apparatus according to one aspect of the embodiments includes a first focus lens, a second focus lens, a first actuator configured to drive the first focus lens, and a second actuator configured to drive the second focus lens. The following inequalities are satisfied:

VMAX1>VMAX2

k1>k2

where VMAX1 is a maximum speed of the first focus lens, VMAX2 is a maximum speed of the second focus lens, k1 is a stroke in an operable range of the first focus lens, and k2 is a stroke in an operable range of the second focus lens. Alternatively, the following inequalities are satisfied:

AMAX1>AMAX2

k1>k2

where AMAX1 is a maximum acceleration of the first focus lens, AMAX2 is a maximum acceleration of the second focus lens, k1 is a stroke in an operable range of the first focus lens, and k2 is a stroke in an operable range of the second focus lens. An image pickup apparatus having the above lens apparatus also constitutes another aspect of the embodiments.

Further features of various embodiments of the disclosure will become apparent from the following description of embodiments with reference to the attached drawings.

### BRIEF DESCRIPTION OF THE DRAWINGS

FIG. 1 illustrates the configuration of an image pickup apparatus according to a first embodiment.

FIG. 2 illustrates a relationship between the positions of a first focus lens and a second focus lens and time in first and third embodiments.

FIG. 3 is a table illustrating parameter values in the first embodiment.

FIG. 4 is a table illustrating parameter values in a second embodiment.

FIG. 5 illustrates the configuration of an image pickup apparatus according to the third embodiment.

FIG. 6 is a table illustrating parameter values in the third embodiment.

### DETAILED DESCRIPTION

Referring now to the accompanying drawings, a detailed description will be given of embodiments according to the disclosure.

### First Embodiment

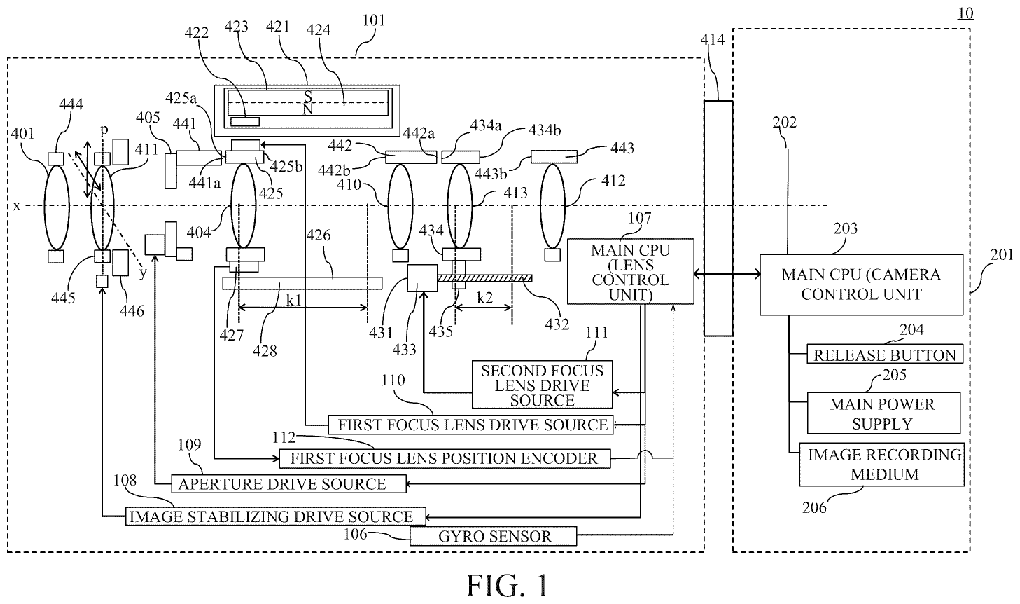

Referring now to FIG. 1, a description will be given of an image pickup apparatus 10 according to a first embodiment. FIG. 1 is a configuration diagram of the image pickup apparatus 10. The image pickup apparatus 10 includes a camera body 201, and a lens apparatus 101 that is attachable to and detachable from the camera body 201. However, this embodiment is not limited to this example, and is also applicable to an image pickup apparatus in which the camera body and the lens apparatus are integrated.

The lens apparatus 101 includes a first (unit) barrel 444, an image stabilizing barrel 445, an aperture (stop) unit 405, a first focus barrel 425, a fourth (unit) barrel 442, a second focus barrel 434, and a sixth (unit) barrel 443. The first barrel 444 holds a first lens 401. The image stabilizing barrel 445 holds an image stabilizing lens 411. The first focus barrel 425 holds a first focus lens 404. The fourth barrel 442 holds a fourth lens 410. The second focus barrel 434 holds a second focus lens 413. The sixth barrel 443 holds a sixth lens 412. The lens held in each barrel is not limited to a single lens, but may be a lens unit including a plurality of lenses. These lenses and the aperture unit 405 constitute an imaging optical system.

The lens apparatus 101 further includes a gyro sensor 106 as a shake detector, and a main CPU (lens control unit) 107 configured to perform overall drive control and calculations for the lens apparatus 101.

The main CPU 107 drives the aperture unit 405 by issuing an instruction to an aperture drive source 109. The main CPU 107 also integrally drives the first focus barrel 425 and the first focus lens 404 by issuing an instruction to a first focus lens drive source 110. The main CPU 107 also issues an instruction to a second focus lens drive source 111 to integrally drive the second focus barrel 434 and the second focus lens 413.

The first focus lens 404 and the second focus lens 413 are arranged in a direction along the optical axis x. The first focus lens 404 and the second focus lens 413 move simultaneously in conjunction with each other during focusing.

The image stabilizing barrel 445 is drivably held in a plane orthogonal to the optical axis x relative to an image stabilizing base barrel 446. During image stabilizing control, the main CPU 107 calculates an image stabilizing amount using a detection value by the gyro sensor 106 and sends an instruction to an image stabilizing drive source 108. The image stabilizing drive source 108 performs image stabilization by driving the image stabilizing barrel 445 in a y-direction (yaw direction) and p-direction (pitch direction), which are axes orthogonal to the optical axis x. Thus, the image stabilizing barrel 445 and the image stabilizing drive source 108 function as an image stabilizing unit.

The aperture unit 405 is fixed to an aperture base 441. The lens apparatus 101 is fixed to the camera body 201 via a mount 414, and captures an object image by imaging it on the image sensor 202 held in the camera body 201 through an optical element (imaging optical system) in the lens apparatus 101.

The camera body 201 includes a main CPU (camera control unit) 203, a release button 204 as an operation member, a main power supply 205, and an image recording medium 206. The release button 204 has a two-step configuration, a first step called SW1 and a second step called SW2. SW1 issues instructions for returning from imaging standby, starting image stabilization, starting autofocus (AF), starting photometry (light metering), and other imaging start preparations. SW2 issues instructions for imaging and recording the image into the image recording medium 206. The main CPU 203 supplies power to the lens apparatus 101 through an unillustrated contact block provided on the mount 414, and communicates other imaging information with the main CPU 107 in the lens apparatus 101.

In this embodiment, the lens apparatus 101 is a fixed focal length lens and does not perform a variable magnification operation. The lens apparatus 101 has an unillustrated fixed barrel, in which the first barrel 444, the image stabilizing base barrel 446, the aperture base 441, the fourth barrel 442, and the sixth barrel 443 are fixed. However, this embodiment is not limited to this example, and is also applicable to a lens apparatus that performs a magnification varying operation.

The first focus barrel 425 is supported by a guide bar fixed to the fixed barrel so that it can linearly move in the optical axis direction. The second focus barrel 434 is supported by a guide bar fixed to the fixed barrel so that it can linearly move in the optical axis direction.

Next, a first actuator 421 will be described. The first actuator 421 is a linear actuator, such as a voice coil motor. However, this embodiment is not limited to this example, and the first actuator 421 may be an actuator other than a linear actuator. A yoke 423 is fixed to a fixed barrel. As illustrated in FIG. 1, a magnet 424 is bipolarly magnetized in a direction orthogonal to the optical axis x and is fixed to the yoke 423. A coil 422 is fixed to the first focus barrel 425 by adhesive or the like, and is disposed in a noncontact manner with the yoke 423 so as to surround the yoke 423 around the optical axis direction as illustrated in FIG. 1. In the space in which the coil 422 is disposed, a magnetic flux flows in a direction orthogonal to the optical axis x due to the magnet 424 and the yoke 423.

When the current is passed through the yoke 423, which is the first focus lens drive source 110, in accordance with the instruction from the main CPU 107, a Lorentz force is generated, and a drive force is generated in the coil 422 on the object side in the optical axis direction or on the image-plane-side in the optical axis direction according to the current direction. Thereby, the first focus barrel 425 and the first focus lens 404 held in it can be driven in the optical axis direction.

Next, a position encoder 426 will be described. The position encoder 426 is, for example, a Giant Magneto Resistive effect (GMR) sensor, but is not limited to this example. A sensor head 427 is fixed to the first focus barrel 425. The magnetic scale of the position encoder 426 is fixed to the fixed barrel. An output according to the position of the first focus barrel 425 is sent from the sensor head 427, which is the first focus lens position encoder 112, to the main CPU 107, and the position of the first focus barrel 425 can be detected. In accordance with this value, the current value to the first focus lens drive source 110 is controlled via the main CPU 107, and thereby the position of the first focus lens 404 is controlled.

The first focus barrel 425 has an object-side end (object-side mechanical end) 425a and an image-plane-side end (object-side mechanical end) 425b. The aperture base 441 has an end 441a corresponding to the object-side end 425a. The fourth barrel 442 has an end 442b corresponding to the image-plane-side end 425b. Thereby, a drivable range (operable range) of the first focus barrel 425, i.e., the first focus lens 404 is limited. In this embodiment, the operable range of the first focus lens 404 is defined as a stroke (first focus lens stroke) k1 of the first focus lens 404. In this embodiment, the lens apparatus 101 is a single focus lens and is in an in-focus state at infinity. As the first focus lens 404 moves toward the image plane side, it transitions to an in-focus state at a close distance, and a position closest to an object is an in-focus position at the closest distance, which is the shortest imaging distance of the lens apparatus 101.

Next, a second actuator (stepping motor) 431 will be described. The second actuator 431 is, for example, an actuator (stepping motor) that converts a rotational force into a drive force in the optical axis direction. However, this embodiment is not limited to this example, and the second actuator 431 may be an actuator other than a stepping motor.

The second actuator 431 includes a motor engine 433 and a leadscrew 432. The second actuator 431 is fixed to the fixed barrel through a metal plate or the like that is coupled to the motor engine 433. In this embodiment, the leadscrew 432 is threaded with a pitch of 0.4. A rack 435 is engaged with the threaded portion of the leadscrew 432. The rack 435 is held by the second focus barrel 434, and is attached so that the holder and the engaged portion of the leadscrew 432 absorb any shift from the ideal position of the second focus barrel 434, i.e., the second actuator 431.

The main CPU 107 issues a pulse drive command to the motor engine 433, which is the second focus lens drive source 111, to drive the second focus barrel 434 holding the second focus lens 413. In this embodiment, the motor engine 433 rotates once with 40 pulses. The second focus barrel 434 is driven by 0.4 mm toward the object side or the image-plane-side according to the direction of rotation. The second focus barrel 434 includes an unillustrated light-shielding fin, and a reference position of the second focus barrel 434 can be recognized by a photo-interrupter attached to the fixed barrel. The main CPU 107 controls the position of the second focus barrel 434 holding the second focus lens 413 under open control by counting pulses from the reference position.

The second focus barrel 434 has an object-side end (object-side mechanical end) 434a and an image-plane-side end (image-plane-side mechanical end) 434b. The fourth barrel 442 has an end 442a corresponding to the object-side end 434a. The sixth barrel 443 has an end 443b corresponding to the image side end 434b. Thereby, a drivable range (operable range) of the second focus barrel 434, i.e., the second focus lens 413 is limited. In this embodiment, the operable range of the second focus lens 413 is defined as a stroke (second focus lens stroke) k2 of the second focus lens 413.

The lens apparatus 101 is a fixed focal length lens, and is in an in-focus state at infinity. A clearance is provided on the object side of the first focus lens 404 and the second focus lens 413 to allow for an in-focus margin at infinity. As the first focus lens 404 and the second focus lens 413 move toward the image-plane-side, they transition to an in-focus state at a close distance. In a case where the first focus lens 404 and the second focus lens 413 are located at positions closest to an object, they are disposed at in-focus positions where they are in focus at the closest distance, which is the shortest imaging distance of the lens apparatus 101.

Now assume that ES1 is an image-plane moving amount (first focus sensitivity) per unit moving amount of the first focus lens 404, ES2 is an image-plane moving amount (second focus sensitivity) per unit moving amount of the second focus lens 413, m1 is the mass of the first focus lens 404 (first focus lens mass), and m2 is the mass of the second focus lens 413 (second focus lens mass). VMAX1 is a maximum speed of the first focus lens 404 driven by the first actuator 421 (maximum first focus lens speed). VMAX2 is a maximum speed of the second focus lens 413 driven by the second actuator 431 (maximum second focus lens speed). Here, the maximum speed means the fastest drive speed among all drives performed by commands from the main CPU 107 in combination with the lens apparatus 101 and the camera body 201. In this embodiment, the magnetic circuit of the first actuator 421 is designed so that VMAX1 is 70 mm/s. This design is based on the movable unit mass including the first focus lens 404, the sliding load between the first focus barrel 425, which is a slider, and a guide bar, the back electromotive force, and the available power.

The second actuator 431 can be driven at a maximum of 3000 PPS (30,000 pulses/second) without stepping out. Since 40 pulses advance 0.4 mm per rotation, VMAX2 is 30 mm/s. In this embodiment, an inequality of VMAX1>VMAX2 may be satisfied. There may be a maximum speed difference of double or more between VMAX1 and VMAX2 (VMAX1>2×VMAX2). That is, VMAX1 may be twice or more as high as VMAX2.

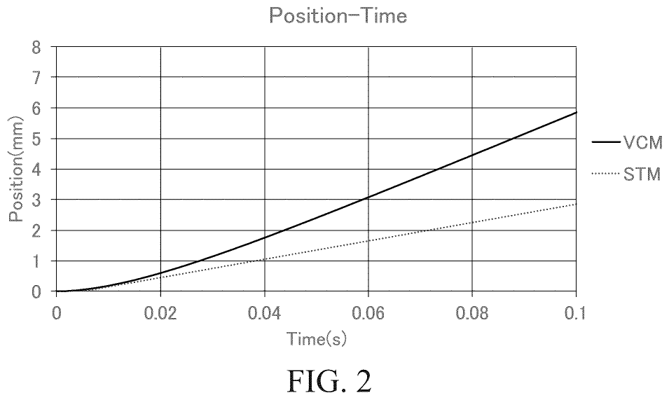

FIG. 2 illustrates a moving locus in 0.1 seconds when each actuator in this embodiment is driven at the maximum output. In FIG. 2, the vertical axis indicates the position (mm) of each focus lens, and the horizontal axis indicates time(s). In FIG. 2, VCM indicates the first actuator 421, and STM indicates the second actuator 431.

The values of the characteristics of the first actuator 421 are calculated under the condition of a movable unit mass of 0.2 kg, a maximum output of 0.1 N, and a velocity resistance coefficient of 1.143 N·s/m, which is a combination of the viscous resistance of the grease and the back electromotive force. Now assume that L1 is a moving distance (first maximum movable distance) per unit time (such as 0.1 seconds) when the first focus lens 404 starts moving from a stopped state with the maximum drive force of the first actuator 421. In this embodiment, L1 is 5.85 mm.

The second actuator 431 has the following accelerations to reach a maximum speed of 3000 PPS; accelerations of 2 pulses at 500 PPS, 2 pulses at 1000 PPS, and 2 pulses at 2000 PPS. Now assume that L2 is a moving distance (second maximum movable distance) per unit time (such as 0.1 seconds) when the second focus lens 413 starts moving from a stopped state with the maximum drive force of the second actuator 431. In this embodiment, L2 is 2.85 mm.

In this embodiment, a relationship of L1>L2 may be satisfied. L1 and L2 may have a difference of double or more (L1>2×L2). That is, L1 may be twice or more as long as L2. Here, the maximum movable distances in “0.1 seconds” are compared because reducing the focusing time is an important issue in the development of the image pickup apparatus, and it is important to extend a driving distance in a short time of about 0.1 seconds.

Assume that AMAX1 is the maximum acceleration of the first focus lens 404, and AMAX2 is the maximum acceleration of the second focus lens 413. In this case, satisfying L1>L2 corresponds to satisfying AMAX1>AMAX2.

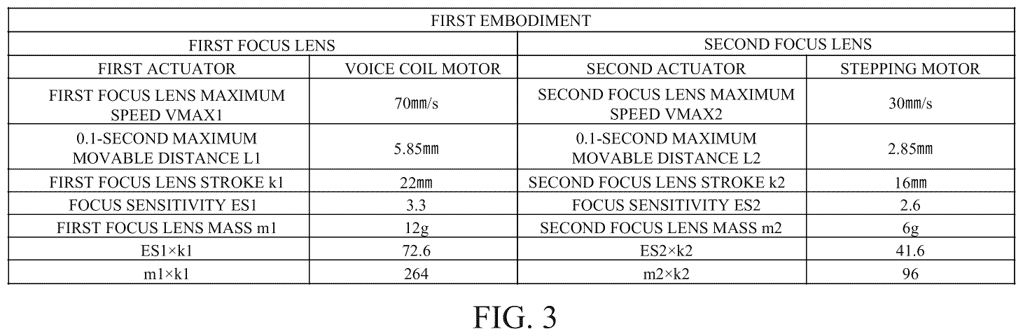

FIG. 3 is a table illustrating the parameter values in this embodiment. The contents of each value are as described above. The first focus lens stroke k1 is 22 mm, and the second focus lens stroke k2 is 16 mm. The first focus sensitivity ES1 is 3.3, and the second focus sensitivity ES2 is 2.6 (|ES1|>|ES2|). The first focus lens mass m1 is 12 g, and the second focus lens mass m2 is 6 g (m1>m2). The actual moving unit mass is this value plus movable units of the focus barrel and actuator.

The product ES1×k1 of the first focus sensitivity ES1 and the first focus lens stroke k1 is 72.6. The product ES2×k2 of the second focus sensitivity ES2 and the second focus lens stroke k2 is 41.6. That is, in this embodiment, |ES1×k1|>|ES2×k2| may be satisfied. Here, the product of the focus sensitivity and the focus lens stroke indicates an image-plane moving amount by the focus lens.

The product m1×k1 of the first focus lens mass m1 and the first focus lens stroke k1 is 264. The product m2×k2 of the second focus lens mass m2 and the second focus lens stroke k2 is 96. In this embodiment, m1×k1>m2×k2 may be satisfied. Here, the product of the focus lens mass and the focus lens stroke indicates a workload required in a case where the lens apparatus is driven in the upward lifting direction, for example.

A description will now be given of the effects of this embodiment. In this embodiment, for example, a voice coil motor is used for the first actuator 421, and a stepping motor is used for the second actuator 431. In this embodiment, at least one of the inequalities VMAX1>VMAX2 and k1>k2 or AMAX1>AMAX2 and k1>k2 is satisfied.

For example, in a case where a stepping motor is used for the first actuator 421, the focus speed is lower than that of a voice coil motor, and the focusing time increases. In particular, with regard to a search drive speed that moves the entire focus stroke from an object distance at infinity to an object distance at a close distance, a difference in maximum speed affects the driving time.

A configuration that performs focusing by driving two focus lenses as in this embodiment is to move the focus lenses at a speed approximately equal to a ratio of the first focus lens stroke k1 to the second focus lens stroke k2. Therefore, in using actuators in which both have approximately the same maximum speed, the side that must be moved faster, the first focus lens 404 in this embodiment, is limited and the second focus lens 413 must be moved slowly. Thereby, the focusing time increases. Even when the full stroke is not moved, the focus lens is to be moved at a speed approximately equal to the ratio of the first focus lens stroke k1 to the second focus lens stroke k2.

Therefore, even for driving a short distance, the first focus lens 404 is to be quickly moved, which has a large stroke. As described above, the first maximum movable distance L1 and the second maximum movable distance L2 in 0.1 seconds from the stop position have a relationship of L1>L2, so that an in-focus state can be acquired even in narrow-range focus drive.

The first focus lens stroke k1 may be 10 mm or more. For example, the first focus lens stroke k1 in this embodiment is 22 mm, which is a relatively long distance. In a case where the first focus lens stroke k1 is short, even if the maximum speed of the first actuator 421 is low, the focusing time reduces and a significant difference does not occur. On the other hand, in the case of a large stroke of 10 mm or more as in this embodiment, the configuration of this embodiment contributes greatly to reducing the focusing time.

Conventionally, a configuration that uses a voice coil motor for both the first actuator 421 and the second actuator 431 is known. In this case, the voice coil motor has a position encoder for control, which requires space and costs, and the size and cost of the lens apparatus increases.

In the case of a voice coil motor, the coil is to be constantly energized to maintain the position, which increases power consumption. In addition, in a case where the voice coil motor is driven, high-frequency magnetic noise is generated from the coil, which may negatively affect the image sensor 202 and the imaging result. As a countermeasure, an LC filter having a coil and a capacitor is to be incorporated into the circuit to cut out unnecessary high-frequency magnetic noise. However, since the coil of the LC filter generates magnetic noise, it is to be placed in front of the lens away from the image sensor. Thus, space for placing the LC filter, including the wiring, is used on the front side of the lens, and thus the size of the lens apparatus is likely to increase. In addition, generally, the first actuator 421 is more expensive than the second actuator 431.

In this embodiment, for example, a voice coil motor is used as the first actuator 421 and a stepping motor is used as the second actuator 431 in accordance with the characteristic of the focus lens. Thereby, the cost and size of the lens apparatus and the focusing time can be reduced. Furthermore, suppressed power consumption can increase the number of images to be captured and reduce the environmental impact.

In this embodiment, the first actuator 421 is a voice coil motor serving as a linear actuator, but it may use another type of linear actuator, such as a linear ultrasonic motor and an electromagnetic linear motor. In this embodiment, the second actuator 431 is a stepping motor serving as an actuator configured to convert a rotational force into a drive force in the optical axis direction, but it may be another type of actuator configured to convert a rotational force into a drive force in the optical axis direction.

### Second Embodiment

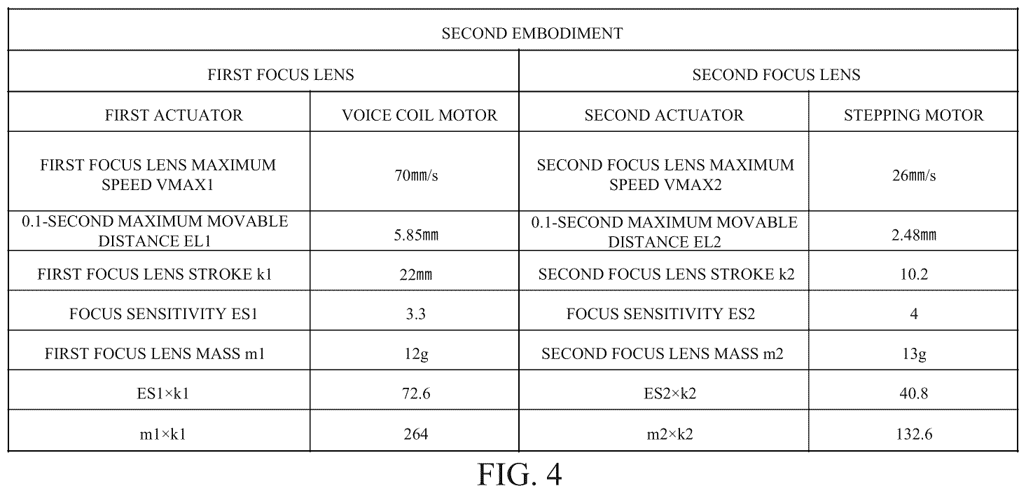

A description will now be given of a second embodiment. FIG. 4 is a table illustrating the parameter values in this embodiment. The basic configuration of the image pickup apparatus according to this embodiment is similar to that of the image pickup apparatus in the first embodiment described with reference to FIG. 1, and therefore a common description will be omitted.

If the second focus lens stroke k2 can be smaller than that of the first embodiment, the overall focusing time can be reduced. In the optical system assumed herein, in order to reduce the second focus lens stroke k2, the second focus sensitivity ES2 is to be increased. This is because the value of the second focus sensitivity ES2×the second focus lens stroke k2, which is an image-plane moving amount for the second focus lens 413, does not significantly change. Therefore, by increasing the second focus sensitivity ES2, the second focus lens stroke k2 can be reduced.

In order to increase the second focus sensitivity ES2, the optical power of the second focus lens 413 is increased. In order to increase the optical power of the second focus lens 413, the number of lenses in the second focus lens 413 is to be increased. In that case, the second focus lens mass m2 tends to increase. In a case where the second focus lens mass m2 increases and the second actuator 431 with the same drive force is used, the maximum speed of the stepping motor is to be reduced. In the stepping motor in which a leadscrew converts a rotational force into a drive force in the axial direction, the main load is rotational sliding loss, so even if the movable unit mass increases, the maximum speed does not decrease by that ratio.

In this embodiment, the maximum speed is 2600 PPS, and the second focus lens maximum speed VMAX2 is 26 mm/s. The second actuator 431 has the following accelerations to reach the maximum speed of 2600 PPS; accelerations of 2 pulses at 500 PPS, 2 pulses at 1000 PPS, and 2 pulses at 2000 PPS. Now assume that L2 is a moving distance (second maximum movable distance) per unit time (such as 0.1 seconds) when the second focus lens 413 starts moving from a stopped state with the maximum drive force of the second actuator 431. In this embodiment, L2 is 2.48 mm.

From the table illustrated in FIG. 4, in this embodiment, the first focus lens maximum speed VMAX1>the second focus lens maximum speed VMAX2 is satisfied. Furthermore, a relationship between the first maximum movable distance L1 and the second maximum movable distance L2 is L1>L2. This corresponds to AMAX1>AMAX2.

A relationship between the first focus lens stroke k1 and the second focus lens stroke k2 is k1>k2. The first focus lens stroke k1 is twice or more as large as the second focus lens stroke k2 (k1≥2×k2). In this embodiment, ES1|<|ES2| and m1<m2 are satisfied. Furthermore, in this embodiment, |ES1×k1|>|ES2×k2| is satisfied. Here, the product of the focus sensitivity and the focus lens stroke indicates an image-plane moving amount by the focus lens.

In this embodiment, m1×k1>m2×k2 is satisfied. Here, the product of the focus lens mass and the focus lens stroke indicates the workload required in a case where, for example, the lens apparatus is driven in an upward lifting direction.

Similarly to the second embodiment, in the first embodiment, in searching the full stroke, the overall drive time is limited by the drive on the second actuator 431 side. In a case where the search time is calculated including acceleration and deceleration, the search time in the first embodiment is short, i.e., 0.54 seconds, and the search time in the second embodiment is also short, i.e., 0.345 seconds. Thus, even in the case of |ES1|<|ES2|, an actuator having a large product of the focus sensitivity and the focus lens stroke may be set to a voice coil motor with a high maximum speed, and an actuator having a small product may be set to a stepping motor. Thereby, this embodiment can provide a lens apparatus with a short focusing time.

Even in the case of m1<m2, an actuator having a large product of the focus lens mass and the focus lens stroke may be set to a voice coil motor with a high maximum speed, and an actuator having a small product may be set to a stepping motor. Thereby, this embodiment can provide a lens apparatus with a short focusing time.

### Third Embodiment

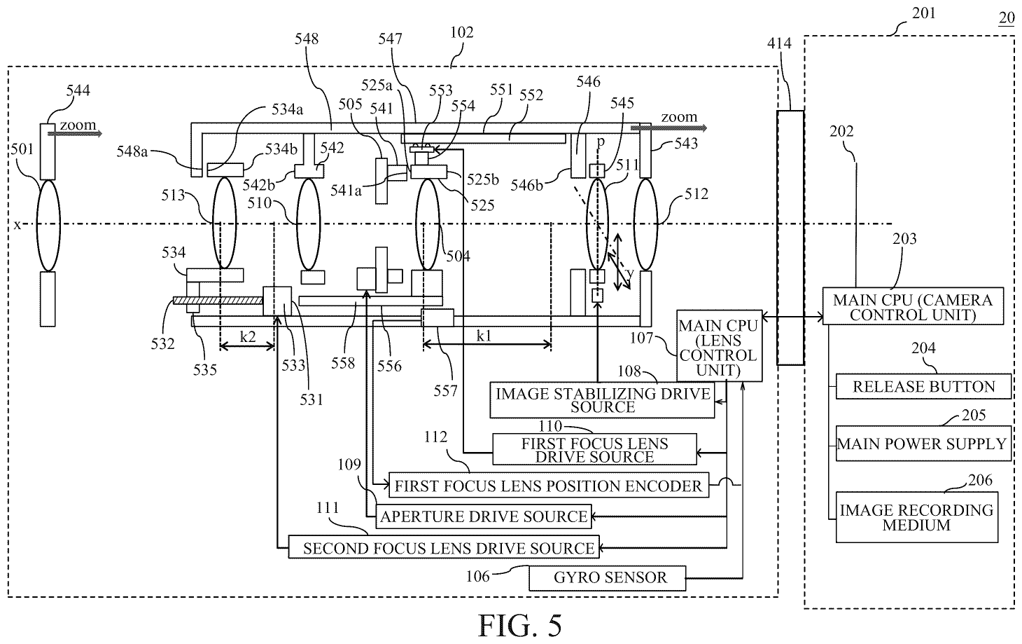

Next, a third embodiment will be described. FIG. 5 is a configuration diagram of an image pickup apparatus 20 according to this embodiment. In this embodiment, a description of parts common to those of the image pickup apparatus 10 according to the first embodiment will be omitted.

The image pickup apparatus 20 includes a camera body 201, and a lens apparatus 102 that is attachable to and detachable from the camera body 201. The lens apparatus 102 includes a first (unit) barrel 544, an image stabilizing barrel 545, an aperture (stop) unit 505, a first focus barrel 525, a 2a(-th) (unit) barrel 542, a second focus barrel 534, and a 2b(-th) (unit) barrel 543. These barrels hold a first lens 501, an image stabilizing lens 511, a first focus lens 504, a 2a(-th) lens 510, a second focus lens 513, and a 2b(-th) lens 512, respectively. The image stabilizing barrel 545 is held drivably in a plane orthogonal to the optical axis x relative to an image stabilizing base barrel 546. The aperture unit 505 is fixed to an aperture base 541.

The lens apparatus 102 according to this embodiment includes a zoom lens and can perform magnification varying operation (to change a focal length). The lens apparatus 102 includes a guide tube and a cam ring (not illustrated). Rollers provided on the first barrel 544 are engaged with cam grooves in the cam ring and linear grooves in the guide barrel. Thereby, the first barrel 544 advances and retreats in the optical axis direction along with the rotation of the zoom ring linked to the cam ring.

Next, a second unit 547 will be described. The second unit 547 includes a second unit base (movable barrel) 548 movable in the optical axis direction according to a change in focal length. The 2a lens 510, the aperture base 541, the image stabilizing base barrel 546, and the 2b lens 512 are fixed to the second unit base 548.

The first focus barrel 525 is supported by a guide bar fixed to the second unit base 548 so that it can linearly move in the optical axis direction. The second focus barrel 534 is supported by a guide bar fixed to the second unit base 548 so that it can linearly move in the optical axis direction.

The rollers provided on the second unit base 548 are engaged with cam grooves in the cam ring and linear grooves in the guide barrel. Thereby, the second unit 547 moves forward and backward in the optical axis direction along with the rotation of the zoom ring, which is linked to the cam ring.

Next, a first actuator 551 will be described. In this embodiment, the first actuator 551 is, for example, a linear vibration-type motor (ultrasonic motor). The first actuator 551 is held by the second unit base 548. A slider 552 is fixed to the second unit base 548. A vibrator 553 is made of a piezoelectric element, and is driven by pressing the contact portion against the slider 552 and applying ultrasonic voltage to the slider 552. A rack 554 plays a role in connecting the vibrator 553 and the first focus barrel 525 while absorbing any shift from the ideal position.

Next, a position encoder 526 will be described. A sensor head 557 is fixed to the second unit base 548. An optical scale 558 is fixed to the first focus barrel 525. An output according to the position of the first focus barrel 525 is sent from the sensor head 557, which is the first focus lens position encoder 112, to the main CPU 107, and the position of the first focus barrel 525 can be detected. The main CPU 107 controls the position of the first focus lens 504 by controlling the current value to the first focus lens drive source 110 according to this value.

The first focus barrel 525 has an object-side end 525a and an image-plane-side end 525b. The aperture base 541 has an end 541a corresponding to the object-side end 525a. The image stabilizing base barrel 546 has an end 546b corresponding to the image-plane-side end 525b. Thereby, a driving range of the first focus barrel 525 holding the first focus lens 504 is limited, and this range is defined as a first focus lens stroke k1. The lens apparatus 102 in FIG. 5 is a zoom lens, and is in an in-focus state at infinity at the WIDE end (wide-angle end). The first focus lens stroke k1 is secured so that an in-focus state can be obtained from infinity to a close distance over the entire zoom range.

Next, a second actuator 531 will be described. The second actuator is, for example, a stepping motor, and is held by the second unit base 548. The second actuator 531 includes a motor engine 533 and a leadscrew 532. The second actuator 531 is fixed to the fixed barrel through a metal plate or the like connected to the motor engine 533. In this embodiment, the leadscrew 532 is threaded with a pitch of 0.4. A rack 535 is engaged with the threaded portion of the leadscrew 532. The rack 535 is held by the second focus barrel 534, and is attached so that the engagement between this holder and the leadscrew 532 absorbs any shift from the ideal position of the second actuator 531 and the second focus barrel 534.

The second focus barrel 534 has an object-side end 534a and an image-plane-side end 534b. The second unit base 548 has an end 548a corresponding to the object-side end 534a. The 2a unit barrel 542 has an end 542b corresponding to the image-plane-side end 534b. Thereby, a drive range of the second focus barrel 534 holding the second focus lens 513 is limited, and this range is defined as a second focus lens stroke k2.

The lens apparatus 102 in FIG. 5 is a zoom lens, and is in an in-focus state at infinity at the WIDE end. The second focus lens stroke k2 is secured so that an in-focus state can be obtained from infinity to a close distance over the entire zoom range.

Now assume that ES1 is an image-plane moving amount per unit moving amount of the first focus lens 504 (first focus sensitivity), and ES2 is an image-plane moving amount per unit moving amount of the second actuator 431 (second focus sensitivity). Also, m1 is the mass of the first focus lens 504 (first focus lens mass), and m2 is the mass of the second focus lens 513 (second focus lens mass).

VMAX1 is a maximum speed of the first focus lens 504 driven by the first actuator 551 (maximum first focus lens speed). VMAX2 is a maximum speed of the second focus lens 513 driven by the second actuator 531 (maximum second focus lens speed). Here, the maximum speed means the fastest drive speed among all drives performed by commands from the main CPU 107 in combination with the lens apparatus 102 and the camera body 201.

In this embodiment, an output characteristic of the first actuator 551 is designed and controlled so that VMAX1 is 100 mm/s. In general, a linear ultrasonic motor can be driven at a high speed with an output higher than that of a stepping motor. This design is to be based on the movable unit mass including the first actuator 551, the sliding load between the first focus barrel 525 as a slider and the guide bar, and the available power.

The second actuator 531 can be driven at a maximum of 3000 PPS (30,000 pulses/second) without stepping out. Since 40 pulses advance 0.4 mm per rotation, VMAX2 is 30 mm/s. At this time, VMAX1>VMAX2 is satisfied, and a maximum speed difference between the two actuators is double or more (VMAX1≥2×VMAX2). That is, VMAX1 is twice or more as high as VMAX2.

In this embodiment, a characteristic of the first actuator 551 has an output capable of accelerating the movable unit including the second focus barrel 534 holding the second focus lens 513 at 12,700 mm/s². At the maximum output, it reaches the maximum speed of 100 mm/s in 0.0079 s from a stopped state. L1 is a moving distance (first maximum movable distance) per unit time (such as 0.1 seconds) when the second focus barrel 534 starts moving from a stopped state with the maximum drive force of the first actuator 551. In this embodiment, L1 is 9.21 mm.

STM in the graph in FIG. 2 indicates the second actuator 531. The second actuator 531 has the following accelerations to reach the maximum speed of 3,000 PPS; accelerations of 2 pulses at 500 PPS, 2 pulses at 1000 PPS, and 2 pulses at 2000 PPS. Now assume that L2 is a moving distance (second maximum movable distance) per unit time (such as 0.1 second) when the second focus lens 413 starts moving from a stopped state with the maximum drive force of the second actuator 531. In this embodiment, L2 is 2.85 mm.

In this embodiment, a relationship of L1>L2 (i.e., AMAX1>AMAX2) is satisfied, and a difference between the two maximum movable distances is double or more (L1>2×L2). That is, L1 is twice or more as long as L2. Here, the maximum movable distances in “0.1 seconds” are compared because reducing the focusing time is an important issue in the development of the image pickup apparatus, and it is important to extend a driving distance in a short time of about 0.1 seconds.

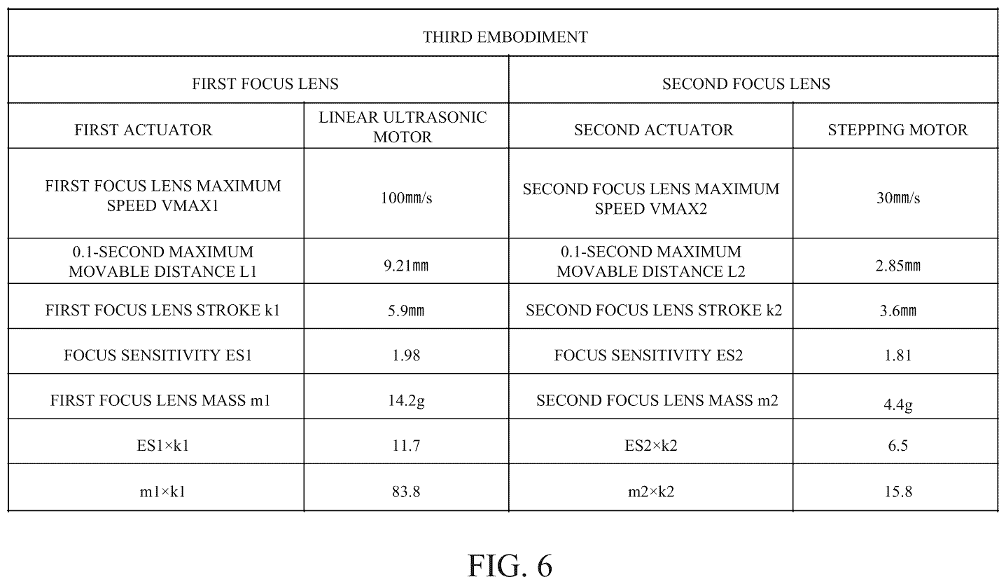

FIG. 6 is a table illustrating the parameter values in this embodiment. The contents of each value are as described above. The first focus lens stroke k1 is 5.9 mm, and the second focus lens stroke k2 is 3.6 mm. The first focus sensitivity ES1 is 1.98, and the second focus sensitivity ES2 is 1.81. The first focus lens mass m1 is 14.2 g, and the second focus lens mass m2 is 4.4 g. The actual moving unit mass is this value plus moving units of the focus barrel and actuator.

The product ES1×k1 of the first focus sensitivity ES1 and the first focus lens stroke k1 is 11.7. The product ES2×k2 of the second focus sensitivity ES2 and the second focus lens stroke k2 is 6.5, so |ES1×k1|>|ES2×k2| is satisfied. Here, the product of the focus sensitivity and the focus lens stroke indicates an image-plane moving amount caused by the focus lens.

The product m1×k1 of the first focus lens mass m1 and the first focus lens stroke k1 is 83.8. The product m2×k2 of the second focus lens mass m2 and the second focus lens stroke k2 is 15.8, and m1×k1>m2×k2 is satisfied. Here, the product of the focus lens mass and the focus lens stroke indicates a workload required in a case where the lens apparatus is driven in the upward lifting direction, for example.

A description will now be given of the effects of this embodiment. In this embodiment, a linear vibration-type motor is used for the first actuator, and a stepping motor is used for the second actuator. In this embodiment, the relationships k1>k2 and VMAX1>VMAX2 are satisfied. For example, in a case where a stepping motor is used for the first actuator, the focus speed is lower than that of a linear vibration-type motor, so the focusing time increases.

There is also a conventional example in which a linear vibration-type motor is used for both the first actuator and the second actuator. In this case, the linear vibration-type motor requires a position encoder for control, which requires space and cost, and the size and cost of the lens apparatus increases.

A linear vibration-type motor requires a transformer, which is an electric element for boosting voltage, and an inductor, which is an electric element for suppressing electric noise. Each of the transformer and the inductor includes a coil portion. Then, while the linear vibration-type motor is driven, magnetic noise is generated from the coil portion, and this may negatively affect the image sensor 202 and deteriorate an imaging result. As a preventive measure, the transformer and the inductor are to be disposed in front of the lens, away from the image sensor. Thus, space for the transformer and the inductor including the wirings is required on the second unit base 548 that holds the first actuator and the second actuator.

The second unit base 548 is a movable unit that moves during zooming, so the space for the transformer and the inductor including the wirings is to be secured in a limited space, and the size of the second unit base 548 including the optical system is to be increased. Thereby, the size of the lens apparatus is likely to increase. On the other hand, this embodiment using a stepping motor as the second actuator can reduce the space for the transformer and the inductor including the wirings on the second unit base 548, and provide a lens apparatus having a reduced size.

Generally, the first actuator 551 is more expensive than the second actuator 531. On the other hand, in this embodiment, the cost can be suppressed by using a stepping motor for the second actuator.

Even in the zoom lens according to this embodiment, in accordance with the characteristic of the focus lens, for example, a linear vibration-type motor is used for the first actuator and a stepping motor is used for the second actuator. Thereby, this embodiment can provide a lens apparatus having a reduced size and cost, and a reduced focusing time.

While the disclosure has described example embodiments, it is to be understood that the disclosure is not limited to the example embodiments. The scope of the following claims is to be accorded the broadest interpretation so as to encompass all such modifications and equivalent structures and functions.

Each embodiment can provide a lens apparatus having a reduced size and focusing time.

This application claims priority to Japanese Patent Application No. 2024-016198, which was filed on Feb. 6, 2024, and which is hereby incorporated by reference herein in its entirety.

What is claimed is:

1. An apparatus comprising:
a first focus lens;
a second focus lens;
a first actuator configured to drive the first focus lens; and
a second actuator configured to drive the second focus lens,
wherein the following inequalities are satisfied:
VMAX1>VMAX2
k1>k2
where VMAX1 is a maximum speed of the first focus lens, VMAX2 is a maximum speed of the second focus lens, k1 is a stroke in an operable range of the first focus lens, and k2 is a stroke in an operable range of the second focus lens.

2. An apparatus comprising:
a first focus lens;
a second focus lens;
a first actuator configured to drive the first focus lens; and
a second actuator configured to drive the second focus lens,
wherein the following inequalities are satisfied:
AMAX1>AMAX2
k1>k2
where AMAX1 is a maximum acceleration of the first focus lens, AMAX2 is a maximum acceleration of the second focus lens, k1 is a stroke in an operable range of the first focus lens, and k2 is a stroke in an operable range of the second focus lens.

3. The apparatus according to claim 2, wherein the following inequality is satisfied:
L1>L2
where L1 is a maximum movable distance per unit time when the first focus lens starts moving from a stopped state with a drive force of the first actuator, and L2 is a maximum movable distance per unit time when the second focus lens starts moving from a stopped state with a drive force of the second actuator.

4. The apparatus according to claim 1, wherein the first actuator is a linear actuator, and the second actuator is an actuator configured to convert a rotational force into a drive force in an optical axis direction.

5. The apparatus according to claim 4, wherein the first actuator is a voice coil motor or a vibration type motor, and
wherein the second actuator is a stepping motor.

6. The apparatus according to claim 1, wherein the following inequality is satisfied:
$$m 1 \times k 1 > m 2 \times k 2$$
m1 is mass of the first focus lens is m1, and m2 is mass of the second focus lens.

7. The apparatus according to claim 1, wherein the following inequality is satisfied:
$$\vert ES 1 \times k 1 \vert > \vert ES 2 \times k 2 \vert$$
where ES1 is focus sensitivity of the first focus lens, and ES2 is focus sensitivity of the second focus lens.

8. The apparatus according to claim 1, further comprising a position encoder configured to detect a position of the second focus lens.

9. The apparatus according to claim 1, wherein the first focus lens and the second focus lens move simultaneously in conjunction with each other during focusing.

10. The apparatus according to claim 1, wherein the following inequality is satisfied:
$$\vert ES 1 \vert > \vert E S2 \vert$$
where ES1 is focus sensitivity of the first focus lens, and ES2 is focus sensitivity of the second focus lens.

11. The apparatus according to claim 1, wherein the following inequality is satisfied:
m1>m2
where m1 is mass of the first focus lens, and m2 is mass of the second focus lens.

12. The apparatus according to claim 1, wherein the stroke of the first focus lens is 10 mm or longer.

13. The apparatus according to claim 1, wherein the following inequality is satisfied:
$$k 1 \geq 2 \times k 2.$$

14. The lens apparatus according to claim 1, wherein the first focus lens and the second focus lens are arranged in a direction along an axis.

15. The lens apparatus according to claim 1, further comprising a movable barrel movable in an optical axis direction according to a change in focal length,
wherein the first actuator and the second actuator are held by the movable barrel.

16. A pickup apparatus comprising:
the apparatus according to claim 1; and
an image sensor.

17. A pickup apparatus comprising:
the apparatus according to claim 2; and
an image sensor.
